(19) United States
(12) Patent Application Publication
(10) Pub. No.: US 2009/0151507 A1
(43) Pub. Date: Jun. 18, 2009

(54) RATCHET WHEEL OF A WRENCH FOR TWO SIZE WORKPIECES

(76) Inventor: Yi-Fu CHEN, Taichung (TW)

Correspondence Address: Yi-Fu, Chen, No.37-2, Ching-Dau 1st Street, Taichung, 404, omitted

(21) Appl. No.: 11/957,472

(22) Filed: Dec. 16, 2007

(51) Int. Cl. G05G 1/00; B25B 13/46

(52) U.S. Cl. 74/575; 81/60

(57) ABSTRACT

The present invention relates to a ratchet wheel of a wrench, which has an opening that penetrates the first and second ends. The opening has twelve identical first recesses that are disposed around the inner periphery of the opening about the central axis, wherein one longitudinal end of the six equidistant first recesses has a stopper portion, said end of the first recess is blocked by the stopper portion. Each of the stopper portions has an identical second recess on the side toward the central axis of the opening. Each of the first recesses comprises two corresponding first angulated portions, wherein the angulated portions of every six equidistant first recesses form a first hexahedral area. Each of the second recesses comprises two corresponding second angulated portions, and the angulated portions of the second recesses form a second hexahedral area. The efficiency of capable of accommodating two different sizes workpieces and restricting the passage of a workpiece through the ratchet wheel are achieved.

### FIELD OF THE INVENTION

The present invention relates to ratchet wheel of a wrench, and more particularly to a ratchet wheel which fits two different sizes workpieces and is provided with stopper portions for restricting the passage of a workpiece through the ratchet wheel.

### BACKGROUND OF THE INVENTION

A conventional ratchet wheel 50 shown in FIG. 12 has an external periphery provided with a plurality of engaging teeth 52 and an inner periphery with twelve V-shaped grooves 51, which can only fit a hexagonal or dodecagonal workpiece. There are many other conventional ratchet wheels designed to be used, such as U.S. Pat. No. 6,488,136 and U.S. Pat. No. 6,148,695. However, those conventional wrench aforementioned has the shortcoming as follows:

1. The twelve V-shaped grooves 51 of the conventional ratchet wheel 50 can only accommodate one size workpiece, but not a smaller or bigger size workpiece, which is inconvenient for use.

2. The conventional ratchet wheel 50 has open ends on both sides of the V-shaped groove 51, and does not have a stopper structure. When the length of a workpiece is longer than the opening of the ratchet wheel 50, the workpiece is easy to pass through the opening due to the gravity of the ratchet wheel 50 or the user's down pressing force, so that it is unable to rotate the workpiece and inconvenient to operate.

### SUMMARY OF THE INVENTION

The primary object of the present invention is to provide an improved structure about the ratchet wheel which is provided with stopper portions for restricting the passage of a workpiece therethrough, and capable of engaging two different sizes workpieces. The ratchet wheel has a ring body having first and second ends and an opening that penetrates the first and second ends. The opening has twelve identical first recesses that are disposed around the inner periphery of the opening about the central axis. The extending direction of each first recess is parallel to the central axis of the opening, wherein one longitudinal end of the six equidistant first recesses has a stopper portion, said end of the first recess is blocked by the stopper portion. Each stopper portion has an identical second recess on the side toward the central axis of the opening. Each first recess comprises two corresponding first angulated portions, wherein the angulated portions of each six equidistant first recesses form a first hexahedral area. Each second recess comprises two corresponding second angulated portions, and the angulated portions of the second recesses form a second hexahedral area.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is a top plan view of the present invention;

FIG. 3 is an enlarge view of A of FIG. 2;

FIG. 4 is a perspective view showing the ratchet wheel engaged a bigger size workpiece according to the present invention;

FIG. 5 is a top plan view of FIG. 4;

FIG. 6 is a perspective view showing the ratchet wheel engaged a bigger size workpiece with another hexahedral area according to the present invention;

FIG. 7 is a top plan view of FIG. 6;

FIG. 8 is a perspective view showing the ratchet wheel engaged a smaller size workpiece according to the present invention;

FIG. 9 is a top plan view of FIG. 8;

FIG. 10 is a top plan view of second embodiment of the present invention engaged a smaller size workpiece by one set of six equidistant second recesses;

FIG. 11 is a top plan view of second embodiment of the present invention engaged a smaller size workpiece by another set of six equidistant second recesses; and

FIG. 12 is a perspective view showing the ratchet wheel engaged a workpiece according to the first prior art.

### DETAILED DESCRIPTION OF THE PREFERRED EMBODIMENT

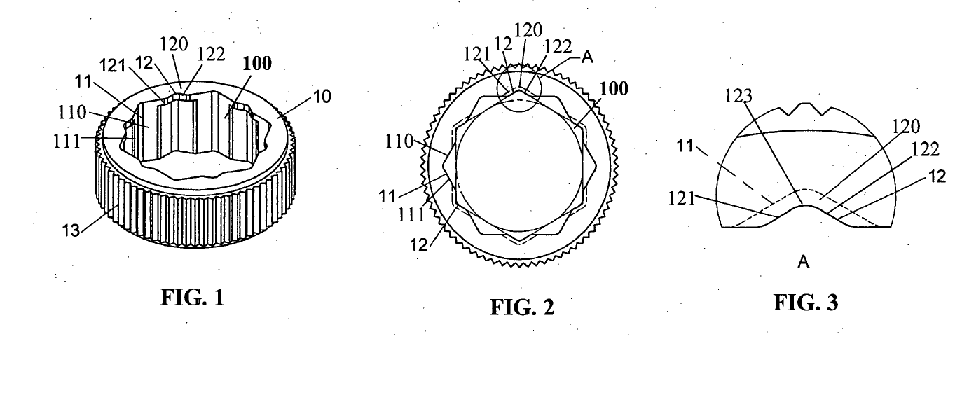

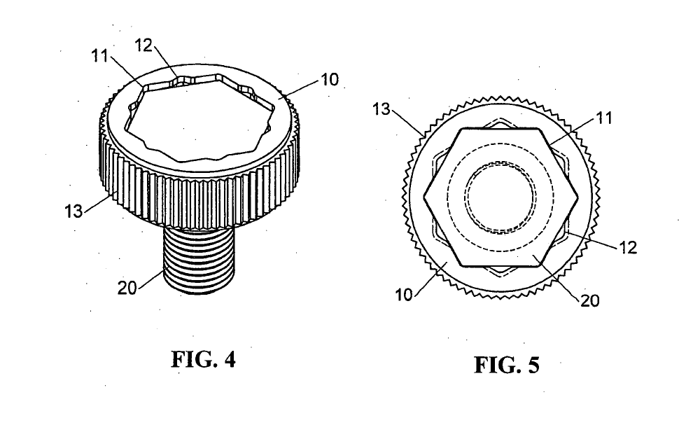

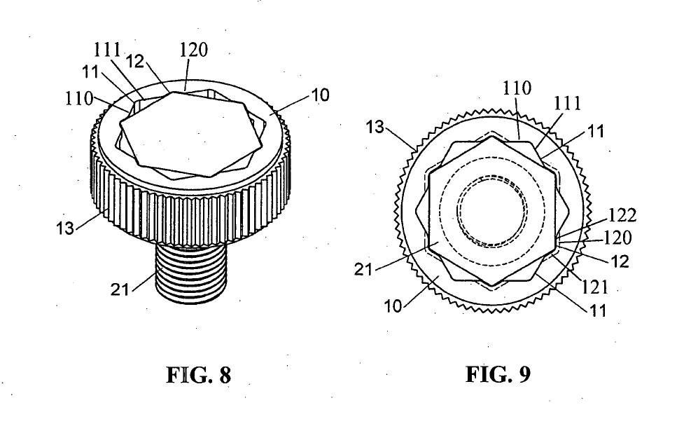

Referring to FIGS. 1 to 3, the present invention is about a ratchet wheel 10 of a wrench, the ratchet wheel 10 has a ring body having a first end and a second end and an opening 100 that penetrates the first end and second end, and an outer periphery provided with a plurality of engaging teeth 13. The opening 100 has twelve identical first recesses 11, which are disposed around the inner periphery of the opening 100 about the central axis. The extending direction of each of the first recesses 11 is parallel to the central axis of the opening 100, wherein one longitudinal end of the six equidistant first recesses 11 has a stopper portion 120, said end of the first recess 11 is blocked by the stopper portion 12. Each of the stopper portions 120 has an identical second recess 12 on the side facing toward the central axis of the opening 100. Each of the first recesses 11 comprises two corresponding first angulated portions 110/111, the angulated portions 110/111 of every six equidistant first recesses 11 form a first hexahedral area. Each of the second recesses 12 comprises two corresponding second angulated portions 121/122, wherein the angulated portions 121/122 of the second recesses 12 form a second hexahedral area. In accordance with the technical features of the present invention, the circumference of the first hexahedral area is longer than the second hexahedral area, namely the first hexahedral area can be used for bigger size workpieces 20 (referring to FIGS. 4-7) and the second hexahedral area can be used for smaller size workpieces (referring to FIGS. 8 and 9). As per the SI system and Imperial system applied in design, the first hexahedral area can be designed to accommodate a workpiece on SI unit, and the second hexahedral area can be designed to accommodate a workpiece on Imperial unit.

Furthermore, referring to FIG. 1, in consideration of the structure strength, the length of the second recess 12 along the central axis of the opening 100 should be designed to be within the range of ⅛ to ½ of the length of the first recess 12.

Referring to FIGS. 1 and 3, the juncture between the two first angulated portions 110/111 on the first recess 11 of the ratchet wheel 10 is shaped as a round corner 112.

Referring to FIG. 3, the juncture between the two second angulated portions 121/122 on the second recess 12 of the driving head 10 is shaped as a round corner 123.

Referring to FIGS. 4 and 5, the ratchet wheel 10 of the present invention uses the first hexahedral area formed by the six equidistant first recesses 11 to engage a bigger size workpiece 20.

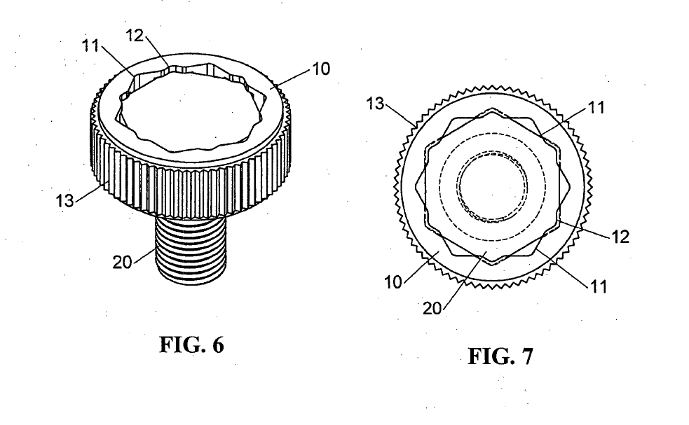

Referring to FIGS. 6 and 7, when the ratchet wheel 10 of the present invention uses the first hexahedral area formed by the six first recesses 12 with stopper portions 120 to engage a bigger size workpiece 20, the workpiece 20 is blocked by the stopper portion 120 from passing through the opening 100, thus the convenience of use is increased.

Referring to FIGS. 8 and 9, the ratchet wheel 10 of the present invention uses the second hexahedral area formed by the six equidistant second recesses 12 to engage a smaller size workpiece 21.

Referring to FIG. 1, the advantage of the present invention is that the six equidistant first recesses 11 can be used for a bigger size workpiece on one hand, and the six equidistant second recesses 12 can be used for a smaller size workpiece on the other. Thus the present invention can be used for two size workpieces. Additionally, the stopper portions 120 of the second recesses 12 can restrict the passage of the workpiece through the opening 100.

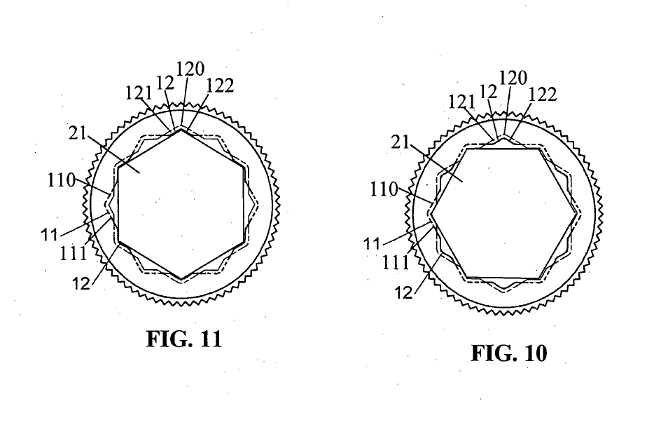

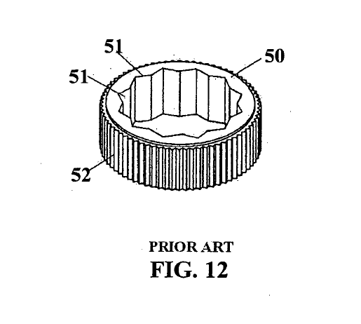

Referring to FIGS. 10 and 11, wherein the number of the equidistant stopper portions 120 is 12, the number of the equidistant second recesses 12 is 12, each stopper portion 120 respectively located on one end of each first recess 11, each second recess 12 respectively located on each stopper portion 120, each six equidistant first recesses 11 is to form the first hexahedral area for receiving the first workpiece, each six equidistant second recesses 12 is to form the second hexahedral area for receiving the second workpiece.

While we have shown and described the embodiment in accordance with the present invention, it should be clear to those skilled in the art that further embodiments may be made without departing from the scope of the present invention.

What is claimed is:

1. A ratchet wheel of a wrench comprising:
a ring body having a first end and a second end;
a plurality of engaging teeth provided on the outer periphery of the ring body;
an opening penetrating the first and second ends;
twelve equidistant first recesses for receiving a first workpiece disposed around an inner periphery of the opening about a central axis of the opening, an extending direction of each first recess being parallel to the central axis of the opening;
at least six equidistant stopper portions, each respectively located on one end of six equidistant first recess, so that one end of the six equidistant first recess being blocked by the stopper portion;
at least six second recesses for receiving a second workpiece with a size smaller than the first workpiece, each respectively disposed on each stopper portion facing toward the central axis of the opening;
two corresponding first angulated portions being provided on each of said first recesses;
a first hexahedral area being formed by the first angulated portions of the six equidistant first recesses;
two corresponding second angulated portions being provided on each second recess; and
a second hexahedral area being formed by the second angulated portions of the six second recesses.

2. The ratchet wheel as claimed in claim 1, wherein a juncture between two first angulated portions of each first recess is shaped as a round corner.

3. The ratchet wheel as claimed in claim 1, wherein a juncture between two second angulated portions of each second recess is shaped as a round corner.

4. The ratchet wheel as claimed in claim 1, wherein the number of the equidistant stopper portions is 12, the number of the equidistant second recesses is 12, each stopper portion respectively located on one end of each first recess, each second recess respectively located on each stopper portion.

5. The ratchet wheel as claimed in claim 1, wherein the number of the equidistant stopper portions is 12, the number of the equidistant second recesses is 12, each stopper portion respectively located on one end of each first recess, each second recess respectively located on each stopper portion, each six equidistant first recesses is to form the first hexahedral area for receiving the first workpiece, each six equidistant second recesses is to form the second hexahedral area for receiving the second workpiece.

6. The ratchet wheel as claimed in claim 1, wherein the first hexahedral area is for accommodating a workpiece on SI unit, and the second hexahedral area is for accommodating a workpiece on Imperial unit

7. The ratchet wheel as claimed in claim 1, wherein the length of second recess along the central axis should be within a range of ⅛ to ½ of length of the first recess along the central axis.
